(19) United States
(12) Patent Application Publication
(10) Pub. No.: US 2002/0094376 A1
(43) Pub. Date: Jul. 18, 2002

(54) Method and devices for producing flexible sheeting including a screened hot-melt adhesive coating

(75) Inventor: Josef Hefele, Grafelfing-Lochham (DE)

Correspondence Address: SCULLY, SCOTT, MURPHY & PRESSER, 400 Garden City Plaza, Garden City, NY, 11530, US

(73) Assignee: Kufner Textilwerke GmbH, Munich (DE)

(21) Appl. No.: 09/906,994

(22) Filed: Jul. 17, 2001

(30) Foreign Application Priority Data
Jan. 16, 2001 (DE) 101 01 664.6

(51) Int. Cl. B05D 5/10; B05D 1/32

(52) U.S. Cl. 427/207.1; 427/259

(57) ABSTRACT

The present invention is directed to a method and devices for producing flexible sheeting including a screened hot-melt adhesive coating wherein said sheeting is based on wovens, knits or non-wovens as mainly employed in garment setting inlays. The coating is accomplished with a paste forming a barrier layer, the imprint of which is powdered with the hot-melt adhesive powder. Excess powder not adhering to the imprint screen is removed by blower/suction means prior to the coating being dried and sintered.

The present invention describes a method and devices for producing flexible sheeting including a screened hot-melt adhesive coating. The sheeting provided with the hot-melt adhesive is based on wovens, knits or non-wovens as mainly employed in garment setting inlays. The coating is done with a paste forming a barrier layer, the imprint of which is powdered with the hot-melt adhesive powder. Excess powder not adhering to the imprint screen is removed by blower/suction means, before the coating is dried and sintered.

Screen coating flexible sheeting with a pasty barrier layer powdered with a layer of hot-melt adhesive powder has been known for a long time, employing mainly a round screening stencil through the holes of which the imprint paste is forced by an inner knife for application to same location at the same time. In this printing procedure, part of the paste, especially when the sheeting is formed by thin coating substrates, penetrates the substrates, mainly through cavities between woven or looped networks, more or less intensively with paste-moistening of the substrate backing and the underroll under the round screening stencil, resulting in a taut feel in setting, nowadays undesirable, whilst back clinching (insert backings adhering to each other in double-setting) cannot always be avoided.

Described in EP 0 792 581 A1 is a modified double layer method in which first a sandwiched substrate is provided with a screened paste imprint which is then transfer printed to the sheeting, after which the transferred pasty screen-layer is powdered with hot-melt adhesive powder. Since in transferring the moist paste there is a risk of the screen pattern being squashed and paste residues may remain on the sandwiched substrate it is hardly possible to achieve neat screening, i.e. smearless without paste also being transferred to the interstices between the screen configurations which likewise results in an excessively taut feel.

It is thus the objective of the present invention to define a method and devices likewise permitting a screened imprint of paste forming a barrier layer on the sheeting with precisely isolated screening and neat interstices and powdering with a hot-melt adhesive powder whilst optimally avoiding a taut feel. In addition, with the intention of further cost savings and further reducing a taut feel the amount of adhesive needed is far less than that known from all screened coatings known hitherto with no detriment to bonding strength and launderability whilst also eliminating back clinching in setting.

This objective is achieved by a coating method and by production devices for flexible sheeting such as wovens, knits and non-wovens including a screened hot-melt adhesive coating comprising the steps of: screened imprinting a barrier-layer forming paste, subsequent powdering with a hot-melt adhesive and removing the excess powder not adhering to the paste imprint, wherein the paste is filled by a knife into either the recesses in an engraved roll or by a knife into the perforations in a round screening stencil, in the latter case with the knife at an obtuse angle in contact with the outer side of the stencil already pasted, and subsequently part of this sole paste filling being applied localized to the applied sheeting and separate in time from the filling and without penetrating the sheeting on application of compression, followed by powdering with the hot-melt adhesive powder. In this production technique the applied paste is applied practically exclusively to the surface of the coating substrate, penetrating it only slightly. Fully penetrating the sheeting, as occurs in inner paste coatings known hitherto is now totally eliminated. The amount of paste imprinted is far less than, or maximally equal to, the amount corresponding to the engraving or perforation volume (perforation volume=cross-section multiplied by the thickness of the product). It has been surprisingly discovered that the total amount needed in each case for coating, whilst being quite considerably less than the coating amounts of all coating methods known hitherto, still achieves good or even better adhesive performance and launderability, whilst also eliminating back clinching (inlay backings sticking to each other in double setting) as often occurs in known paste/powder coatings.

In the first cited mode of coating in accordance with the invention the engraving of an unheated or cooled roll is filled with paste by a knife usually applied at an acute angle, the sheeting then being pressed against the engrave filling by a backing roll which may be heated or not heated and may feature a rubberized or a plain steel surface. In this arrangement, part of the engrave filling is applied to the surface of the sheeting, the coating substrate. The remainder remains in the engraving which on return to the filling location is refilled. The coating substrate provided with the paste imprint is then uniformly powdered with the hot-melt adhesive powder and subsequently the surface of the substrate air jetted/vacuumed, resulting in many of the powder grains still to contact the moist screening thereby being brought into contact therewith and anchoring thereto in part. The concluding non-adhering excess powder is vacuumed for recycling. After having left the blower/suction station the complete coating is dried and sintered.

In the second cited mode of coating, an outwardly smoothly ground round screening stencil is knifed with paste from without such that the perforations are filled more or less completely and the paste is at first unable to be urged to the inner side of the screening stencil, or hardly so. This always occurs when the paste has a sufficiently high viscosity and when the paste knife is applied at an obtuse angle of approx. 130 to 170° to the outer wall of the screening stencil. Locating the stencil perpendicularly from underneath is a backing roll featuring either a soft rubberized finish or configured as a plain steel roll. The coating substrate is infed in the line of contact between stencil and backing roll and an inner knife located above the line of contact is powerfully urged in the stencil with no additional supply of inner paste. This causes part of the amount of paste filling the perforations to be applied to the surface of the coating substrate without penetrating thereinto. On return of the rotating round screening stencil to the outer knife the perforations are refilled. The printed substrate is then powdered, air jetted, vacuumed, dried and sintered the same as in the first cited mode.

Initial tests with the second cited coating technique provided no indication that part of the perforation filling can be applied to the coating substrate in a trial coating with an obtuse located knife for a screening stencil provided in a single plane, as a result of which no or hardly any powdered hot-melt adhesive adhered to the substrate. Surprisingly, however, it was discovered that transfer of the perforation filling took place until an even balance in a constant coating amount after but a few turns of the round screening stencil in making the coating under production technical conditions.

Referring now to FIG. I there is illustrated a production device comprising an engraved roll (1), a rubberized backing roll (2), a pasting knife (3), a paste feed (4), a coating substrate before and after coating with a screened paste imprint (6) and additional powder coating (7). The powderer (8) is used for powdering and the blower and suction means (9) for finalizing the powder coating on the paste imprint. The subsequent drying and sintering means are not shown.

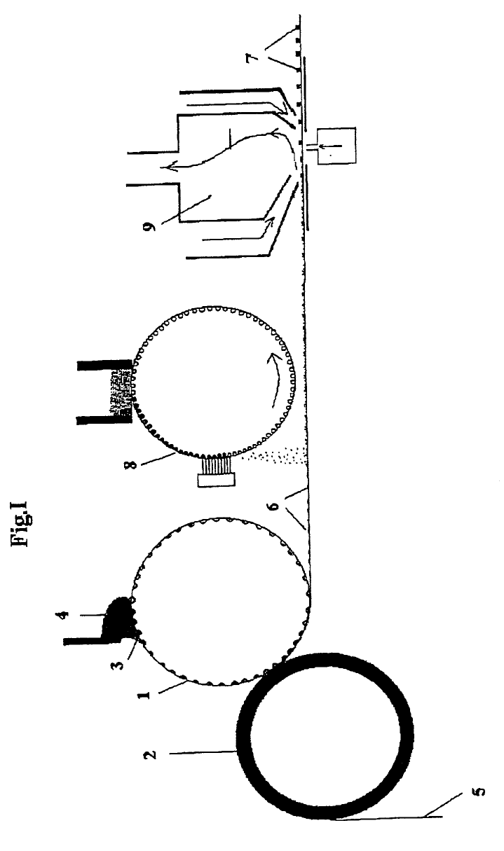

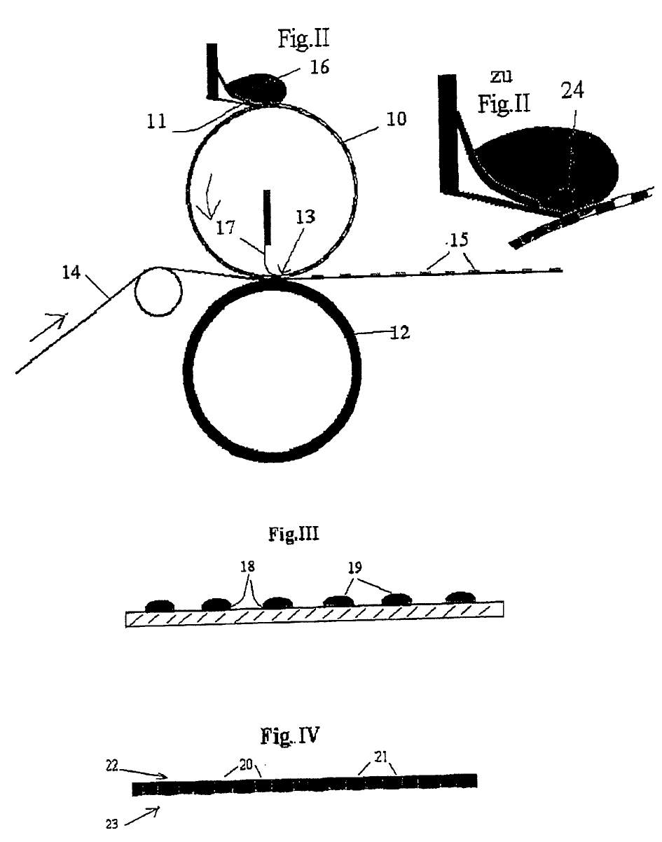

Referring now to FIG. II there is illustrated a production means comprising a round screening stencil (10) whose perforations are practically filled up to the zenith height of the stencil from without by the knife (11) applied at an obtuse angle (24) of approx, 130-170°. The screening stencil is contacted from underneath by a rubberized underroll (12) which also contacts the coating substrate (14) infed and outfed in the contact line (13). Via the contact line stencil-substrate-underroll-the knife (17) is urged with no additional presented inner paste into contact by its tip with the stencil and prompts with the assistance of the rubberized underroll transfer of a major portion of the perforation filling with paste (16) through the coating substrate in forming the screened paste spots (15). Not shown in FIG. 2 are the subsequent powdering, suction and blower as well as drying and sintering means.

The amount of paste applied can be controlled by the amount of paste presented upstream of the knife (11). When a large amount is presented a minute bead of paste can form upstream of the knife (17). When a lesser amount is presented, forming this bead is practically or totally eliminated. To set the amount as presented upstream of the knife (11) a level sensor (not shown) may be used. Referring now to FIG. III there is illustrated in a further diagrammatic view a coated sheeting including a thin screened barrier layer (18) applied to the surface and a sintered layer of hot-melt adhesive powder (19). Referring in conclusion to FIG. IV there is illustrated the paste filling (20) of the perforations of a screen stencil (18) as well as the outer side (22) and inner side (23) of the stencil.

Use is made preferably of spot screens and thin substrates when the method and devices are employed for finer screen coatings; suitable spot screens being 17 to 30 mesh and more (mesh being understood as the number of perforations as measured linearly for an arrangement of all perforations at the corners of an Isosceles triangle).

The barrier layer pastes may be based on aqueous thickenings of high melt/viscous fine hot-melt adhesive powders of copolyamides, copolyesters, polyurethanes or low-pressure polythenes, also containing polyurethane dispersions, cross-linking poly(meth)acrylate dispersions, PVC powders and PVC plasticizers.

It is good practice to formulate the paste viscosity relatively high and may be in the range 15,000 to 25,000 cP. The hot-melt powder used for powdering should have a grain size in the range 80 to max 200 μm and constitute low melt/viscous copolyamides, copolyesters, polyurethanes or also polythenes.

The following basic examples outline the invention.

### EXAMPLE 1

Engraved Roll with Rubberized Backing Roll

both cold

engraved recess density: 80/cm2

engraved recess depth: 0.27 mm

engraved depth 0.18 mm

Paste Composition

PVC plus plasticizer 1:1:10%

dry residue, cross-linked polyacrylate 3.5%

dry residue, additives 1%

dry residue, thickener 2%

remainder water

paste viscosity 15,000-25,000 cP

hot-melt adhesive powder: low-melting copolyamide powder 80-160 μm

coating substrate: knit with texturized polyester yarn 25 g/m²

coating weight: total 5.0 g/m², of which approx. 1 g/m² barrier layer and approx. 4.0 g/m² hot-melt adhesive

coating tolerance: +/−0.5 g/m² (specimen 100 cm²)

bonding strength (in continuous thruput press at 127° C. in setting gap, blouse outer material of polyester) better than 13 N/5 cm

### EXAMPLE 2

Externally Ground Screen Stencil with Outer Knife Locating Obtuse at an Angle of 150° and Rubberized Backing Roll

stencil perforation density: 80/cm²

perforation diameter: 0.30 mm

wall thickness of ground stencil: 0.19 mm

perforation drain in continuous operation: approx. 60% of full perforation volume (volume=hole cross-section multiplied by wall thickness of ground stencil)

paste composition: see above

paste viscosity: see above

coating tolerance: see above

hot-melt adhesive powder: see above

coating substrate: see above

coating weight: see above

bonding strength: see above

1. Method for producing screened coatings on flexible sheeting such as wovens, knits and non-wovens, mainly for garment fabrication, including hot-melt adhesives, comprising the steps of screen imprinting a paste forming a barrier-layer, subsequent powdering with a hot-melt adhesive powder and removing the excess powder not adhering to the paste imprint, wherein said paste is filled by a knife into either the recesses in an engraved roll or by a knife into the perforations in a round screening stencil, in the latter case with said knife at an obtuse angle in contact with the outer side of said stencil presented with paste, and subsequently part of this sole paste filling being applied localized to said applied sheeting and separately in time from said filling and without penetrating said sheeting when compressed in using a backing roll, followed by powdering with said hot-melt adhesive powder.

2. The method as set forth in claim 1 wherein said paste is filled into the recesses of an unheated engraved roll and subsequently transferred by an unheated rubberized backing roll to said sheeting.

3. The method as set forth in claim 1 wherein said paste is filled into the recesses of a cooled engraved roll and subsequently transferred by a heated steel-surfaced backing roll to said sheeting.

4. The method as set forth in any of the claims 1-3 wherein a backing roll presses said coating substrate against said engraved roll.

5. The method as set forth in claim 1 wherein said paste is filled into the perforations of said screening stencil by an outer knife locating said outer smooth ground surface of said round screening stencil at an obtuse angle of approx. 130 to 170° such that it roughly fills maximally the volume of said perforations (=cross-section multiplied by stencil wall thickness).

6. The method as set forth in claims 1 and 5 wherein paste is transferred to said sheeting by the contact pressure of an inner knife in said screening stencil with no further inner paste feed.

7. The method as set forth in any of the claims 1 to 6 wherein the viscosity of said paste is high, roughly in the range 15,000 to 25,000 cP.

8. The method as set forth in any of the claims 1 to 7 wherein said paste contains PVC, PVC plasticizer and cross-linked poly(meth)acrylates.

9. A device for implementing the method as set forth in any of the claims 1-8 comprising a paste impression device including an engraved roll for contacting a rubberized or non-rubberized backing roll, a knife contacting said engraved roll, means for supplying said paste, feeding said coating substrate into the nip between engraved roll and backing roll and forwarding said pasted substrate under a powderizer for applying said hot-melt adhesive powder, followed by an blower/suction device and a drying/sintering means.

10. A device for implementing the method as set forth in any of the claims 1-8 comprising a paste impression device including a round screening stencil ground smooth on the outside, an outer knife locating said screening stencil at an angle of approx. 130 to 170° and an external paste feeder, an inner knife with no inner paste feed and a backing roll contacting said screening stencil under the line of contact of said inner knife edge followed by an blower/suction device and a drying/sintering means.
